(19) United States
(12) Patent Application Publication
(10) Pub. No.: US 2024/0198718 A1
(43) Pub. Date: Jun. 20, 2024

(54) PAINT TRAY COUPLER SYSTEM

(71) Applicant: PEGITZ, LLC, San Diego, CA (US)

(72) Inventor: Stephen Wall, San Diego, CA (US)

(73) Assignee: PEGITZ, LLC, San Diego, CA (US)

(21) Appl. No.: 18/341,405

(22) Filed: Jun. 26, 2023

Related U.S. Application Data
(60) Provisional application No. 63/355,945, filed on Jun. 27, 2022.

(51) Int. Cl. B44D 3/12

(52) U.S. Cl. CPC B44D 3/126

(57) ABSTRACT

A paint tray coupler system is disclosed. The system has one or more liner couplers coupled to a side of the paint tray for engaging a paint tray liner. The liner coupler is configured to provide a downward force, a side force, or both against the paint tray liner. The liner coupler may include a clasp lever, clamp, latch, or the like. The liner coupler may be coupled to the paint tray at an outer side surface. In some embodiments, the paint tray coupler system may include an additional liner coupler coupled to the outer side surface on an opposite side.

### CROSS-REFERENCE TO RELATED APPLICATIONS

This application claims benefit of priority with U.S. Provisional Application Ser. No. 63/355,945 filed Jun. 27, 2022; the entire contents of which are hereby incorporated by reference.

### BACKGROUND

### Field of the Invention

This disclosure relates to a paint tray, and more particularly to a paint tray with coupler configured to engage a paint tray liner.

### Description of the Related Art

A paint tray is used to hold paint for decorating with a paint roller, typically having a well and a ridged slope with which to spread paint evenly over the roller. Oftentimes, a paint tray liner is used to allow for greater efficiency in completion of painting projects by removing the necessity to clean out paint trays in between new colors or coats, or at the end of a painting session.

Paint tray liners are generally low cost and disposable, removing the need to clear leftover or dried paint. However, both the paint trays and the paint tray liners can have slightly different dimensions which causes an undesirable fit between many paint tray liners and paint trays. During transportation or while using the roller with a loose-fitting paint tray liner can cause it to move around or slide. This can create spills and uneven spreading of paint on the roller.

There is a need for a better fitting paint tray liner used in conjunction with the paint tray.

### SUMMARY

A paint tray coupler system is disclosed. The system comprises one or more liner couplers coupled to a side of the paint tray for engaging a paint tray liner. The liner coupler is configured to provide a downward force, a side force, or both against the paint tray liner.

The liner coupler may comprise a clasp lever, clamp, latch, or the like.

The liner coupler may be coupled to the paint tray at an outer side surface of a first major side. In some embodiments, the paint tray coupler system may further comprise an additional liner coupler coupled to the outer side surface of a second major side opposite the first major side.

In some embodiments, at least one of the liner couplers is disposed at an upper portion of the paint tray. In some embodiments, each of the liner couplers is disposed at the upper portion.

### BRIEF DESCRIPTION OF THE DRAWINGS

Other features, combinations, and embodiments will be appreciated by one having the ordinary level of skill in the art upon a thorough review of the following details and descriptions, particularly when reviewed in conjunction with the drawings, wherein:

FIG. 1 shows a top view of a conventional paint tray;

FIG. 2 shows perspective view of a paint tray coupler system in accordance with a first illustrated embodiment;

FIG. 3 shows a side view of the paint tray coupler system in an open state in accordance with a second illustrated embodiment;

FIG. 4 shows a side view of the paint tray coupler system in a closed state according to the second illustrated embodiment;

FIG. 5 shows a perspective view of the paint tray coupler system in accordance with a third illustrated embodiment;

FIG. 6 shows a perspective view of the paint tray coupler system holding a paint tray liner according to the third illustrated embodiment;

FIG. 7 shows a top view of the paint tray coupler system holding a paint tray liner according to the third illustrated embodiment;

FIG. 8A-8F show alternative configurations of liner couplers coupled to the paint tray;

FIG. 9 shows a perspective view of a liner coupler according to a fourth illustrated embodiment;

FIG. 10 shows a plan view of a coupler mounting element used in conjunction with a liner coupler;

FIG. 11A shows a front view of a liner coupler in accordance with a fifth illustrated embodiment;

FIG. 11B shows a rear view of the liner coupler according to the fifth illustrated embodiment;

FIG. 12 shows a front view of a coupler mounting element according to the fifth illustrated embodiment;

FIG. 13 shows a side view of the coupler mounting element according to the fifth illustrated embodiment;

FIG. 14 shows the liner coupler engaged with the coupler mounting element in an unlocked position according to the fifth illustrated embodiment;

FIG. 15 shows the liner coupler engaged with the coupler mounting element in a locked position according to the fifth illustrated embodiment;

FIG. 16 shows a perspective view of the liner coupler engaged with a paint tray liner according to the fifth illustrated embodiment;

FIG. 17A shows a front view of a liner coupler in accordance with a sixth illustrated embodiment; and

FIG. 17B shows a rear view of the liner coupler according to the sixth illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

Unless explicitly defined herein, terms are to be construed in accordance with the plain and ordinary meaning as would be appreciated by one having skill in the art.

### General Description of Embodiments

In one embodiment, a paint tray coupler system is disclosed. The paint tray coupler system comprises a paint tray, a coupler mounting element, and a liner coupler. The paint tray has a plurality of sides, the plurality of sides comprising a first major side, a second major side opposite the first major side, a first minor side and a second minor side opposite the first minor side. Each of the plurality of sides comprises a periphery edge, an inner side surface and an outer side surface opposite the inner side surface. The paint tray further comprises an upper portion and a lower portion wherein a well is disposed at the upper portion and a ridge slop is disposed at the lower portion. The coupler mounting element is disposed on the outer side surface of one of the plurality of sides, and the liner coupler is configured to couple to the coupler mounting element, the liner coupler comprising a handle element configured to couple to the coupler mounting element, and a latch element rotatably coupled to the handle element.

In some embodiments, the coupler mounting element may further comprise a first aperture and a second aperture wherein the liner coupler is configured to engage with the coupler mounting element at each of the first aperture and second aperture.

In some embodiments, the liner coupler may further comprise a first looped formation and a second looped formation, wherein the first looped formation and the second looped formation are each disposed on the handle element, the latch element, or both. The first and second looped formations may be integrally formed onto the handle element, the latch element, or both. In other embodiments, the first looped formation and the second looped formation each comprise a plurality of bends of the handle element, the latch element, or both.

In some embodiments, the latch element may further comprise a first latch terminal end and a second latch terminal end, wherein the first latch terminal end is configured to extend through the first looped formation and the second latch terminal end is configured to extend through the second looped formation.

In some embodiments, the handle element may further comprise a first handle terminal end and a second handle terminal end, wherein the first handle terminal end is configured to extend through the first looped formation and the second handle terminal end is configured to extend through the second looped formation.

In some embodiments, the handle element may be configured to rotatably couple to the coupler mounting element.

In some embodiments, the liner coupler may be detachably coupled to the coupler mounting element.

In some embodiments, the system may further comprise a plurality of coupler mounting elements wherein at least one of the plurality of coupler mounting elements is disposed on the outer side of each of the plurality of sides.

In some embodiments, the coupler mounting element may be integrally formed with the paint tray.

In some embodiments, the coupler mounting element may further comprise a mounting plate wherein the mounting plate is coupled to the outer side surface.

In some embodiments, the system may further comprise a paint tray liner disposed on top of the well and the ridge slope, the paint tray liner configured to cover the periphery edge wherein a portion of the paint tray liner is disposed between the periphery edge and the latch element.

In some embodiments, the latch element may be configured to be disposed above the periphery edge.

In some embodiments, the handle element may be configured to be disposed below the periphery edge.

In some embodiments, the handle element and the latch element may be configured to form a locked state.

In some embodiments, the liner coupler may be configured to apply a downward force, a sideways force, or both to the periphery edge.

In some embodiments, the latch element may further comprise a curvature configured to engage with the periphery edge.

In some embodiments, the liner coupler may be disposed at the upper portion.

In another embodiment, a paint tray coupler system is disclosed. The paint tray coupler system comprises a paint tray having a plurality of sides, the plurality of sides comprising a first major side, a second major side opposite the first major side, a first minor side and a second minor side opposite the first minor side. Each of the plurality of sides comprises a periphery edge, an inner side surface and an outer side surface opposite the inner side surface, the paint tray further comprising an upper portion and a lower portion wherein a well is disposed at the upper portion and a ridge slop is disposed at the lower portion. The paint tray coupler system further comprises one or more liner couplers configured to couple to the outer side surface.

In some embodiments, at least one of the one or more liner couplers may be disposed at the upper portion.

In some embodiments, at least one of the one or more of liner couplers may comprise a clasp lever having a channel configured to cover the periphery edge, the channel further configured to extend downwards at both the inner side surface and the outer side surface, a rivet rotatably coupled to the outer side surface to allow the clasp lever to move up and down for securing a paint tray liner, and a tab coupled to the rivet opposite the clasp lever.

In some embodiments, at least one of the one or more liner couplers may comprise a first terminal end and a second terminal end each coupled to the outer side surface, a plurality of bends including a first bend, a second bend, a third bend, and a fourth bend, a first top-adjourning portion disposed between the first and third bends, a second top-adjourning portion disposed between the second and fourth bends, wherein the first top-adjourning portion and the second top-adjourning portion are each configured to engage with the periphery edge, and an inner side adjourning portion extending between the third and fourth bends, the inner side adjourning portion configured to engage with the inner side surface.

### Manufacturing

Each of the components of the paint tray coupler system described herein may be manufactured and/or assembled in accordance with the conventional knowledge and level of a person having skill in the art. Paint trays are generally made of lightweight metal or plastic as is known in the art. The liner couplers may additionally comprise metal and/or plastic having sufficient flexibility and durability needed to engage a paint tray liner as can be appreciated by one having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

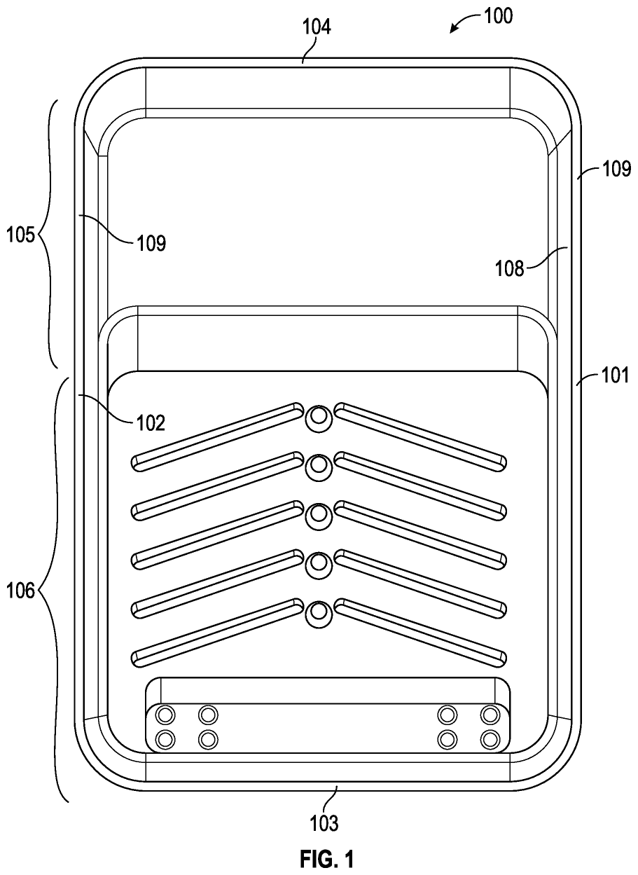

Now turning to the drawings, FIG. 1 shows a top view of a conventional paint tray (100). The paint tray comprises a first major side (101), a second major side (102), a first minor side (103), and a second minor side (104). The paint tray further comprises a well disposed at an upper portion (105) and a ridged slope disposed at a lower portion (106). Disposed along each of the first major side, second major side, first minor side, and second minor side is a periphery edge (109), wherein the periphery edge extends outward to allow for easy stacking of the paint tray and further to allow a paint tray liner to couple therewith. Each of the first major side, second major side, first minor side, and second minor side comprises an inner side surface (108) and an outer side surface (not shown) opposite the inner side surface.

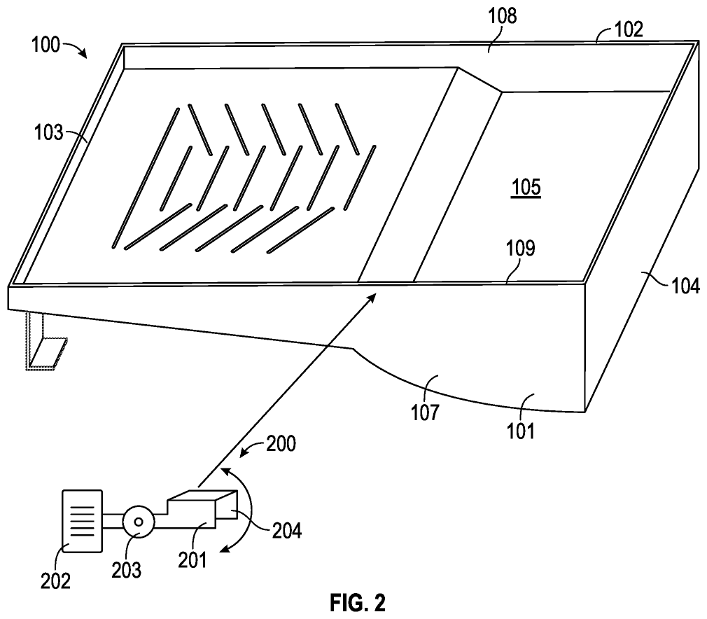

FIG. 2 shows perspective view of a paint tray (100) with liner coupler (200) in accordance with a first illustrated embodiment. The liner coupler is fixedly coupled to an outer side surface (107) of a first major side (101) of the paint tray. The liner coupler is shown disposed on the first major side at an upper portion (105). This can provide a stronger hold as a majority of paint contained within the paint tray lays at the upper portion. The liner coupler may be alternatively or additionally disposed at other portions of the first major side. A secondary liner coupler may be symmetrically coupled to a second major side (not shown) opposite the first major side.

The liner coupler comprises a clasp lever (201) having a channel (204) configured to cover a periphery edge (109) of the paint tray (100) and further configured to extend downwards at both an inner side surface (108) and an outer side surface (107). The liner coupler is rotatably coupled to the outer side surface by a rivet (203) to allow the clasp lever to move up and down for releasing and securing a paint tray liner. Other means of coupling the liner coupler may also be used as can be appreciated by one having skill in the art. A tab (202) is coupled to the rivet opposite the clasp lever, the tab being configured to be pressed or pulled by a user for moving the clasp lever. In some embodiments, the liner coupler may further comprise a spacer that will offset the clasp lever beyond the periphery edge, thereby allowing the clasp lever to freely move up and down without contacting the periphery edge.

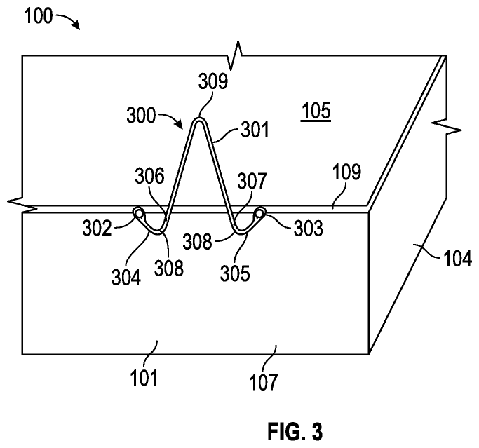

FIG. 3 shows a side view of the paint tray (100) with liner coupler (300) in an open state in accordance with a second illustrated embodiment. The liner coupler comprises a clamp (301) having a first terminal (302) end and a second terminal end (303) each coupled to an outer side surface (107) of a first major side (101) of the paint tray. The liner coupler Is configured to wrap around a periphery edge (109) of the paint tray and abut an inner side surface (108). The liner coupler includes a first bend (304), a second bend (305), a third bend (306), and a fourth bend (307), thereby creating a top-adjoining portion (308) disposed between the first and third bend, and additionally disposed between the second and fourth bends. The top-adjoining portions are configured to press against the periphery edge to provide a downward force onto a paint tray liner. The liner coupler further comprises an inner-side adjoining portion (309) which extends from both the third and fourth bends. The inner-side adjoining portion is configured to press against the inner side surface and provide a side force against the paint tray liner and the inner side surface of the paint tray. With two liner couplers disposed on opposite sides of the paint tray, the corresponding paint tray liner will undergo a downward force from each of the top-adjoining portions, and further undergoes opposing side forces due to each of the inner-side adjoining portions being disposed on opposite sides of the paint tray.

The liner coupler (300) is shown in an open state before a paint tray liner is installed. The liner coupler may be rotatably coupled to the outer side surface (107) at the first and second terminal ends (302; 303), wherein while in the open state the liner coupler is free to rotate around the periphery edge (109), and while in a closed state, the liner coupler is in a locked state requiring additional force to disengage. Such a locked state can be achieved by friction at the first and second terminal ends coupling to the outer side surface, and/or by friction of the clamp (301) with the periphery edge and inner side surface (108). In alternative embodiments, the liner coupler may be configured to bend and flex over and around the periphery edge to the inside side surface.

As shown, the liner coupler (300) comprises a wired-structure. In other embodiments, the liner coupler may comprise a singular flat portion comprising a single terminal end or double end having a plurality of bends configured to allow the liner coupler to wrap around the periphery edge (109) and press against the inner side surface (108).

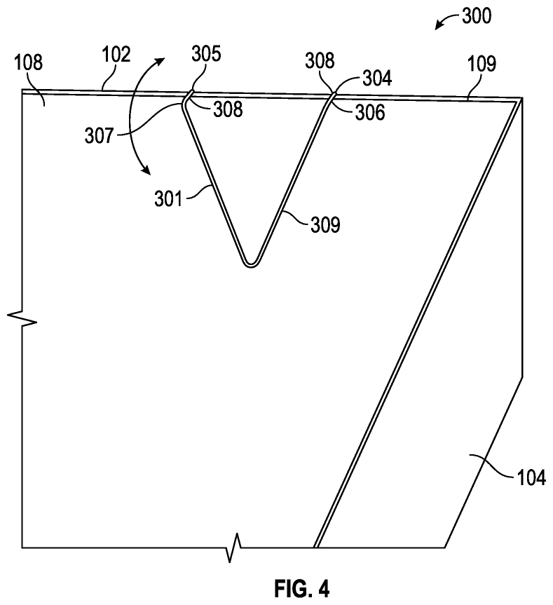

FIG. 4 shows a side view of the paint tray (100) with liner coupler (300) in a closed state according to the second illustrated embodiment. The liner coupler is coupled to the paint tray at an outer side surface (not shown) and is configured to press against both a periphery edge (109) and an inner side surface (108) of the paint tray. Specifically, the liner coupler comprises a top-adjoining portion (308) disposed between a first bend (304) and a third bend (306) and further comprises an additional top-adjoining portion disposed between a second bend (305) and a fourth bend (307). An inner-side adjoining portion (309) extends from both the third and fourth bends and is configured to press against the inner side surface.

As shown, the liner coupler (300) comprises a wired-structure. In other embodiments, the liner coupler may comprise a single flat piece wherein the first and second bends (304; 305) form a single bend, and the third and fourth bends (306; 307) additionally form a single bend.

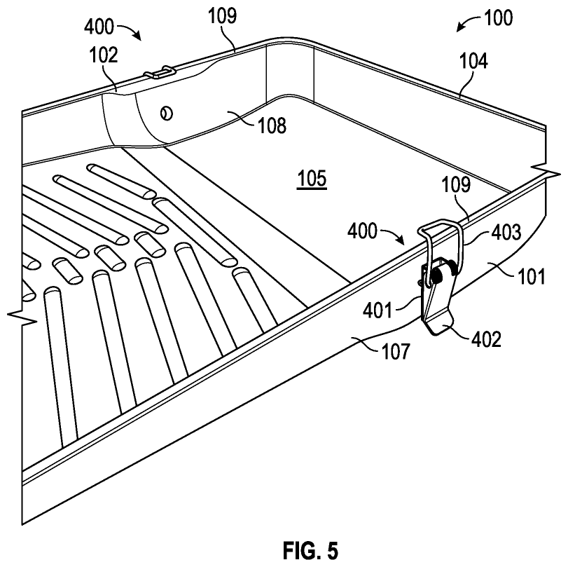

FIG. 5 shows a perspective view of the paint tray (100) with liner coupler (400) in accordance with a third illustrated embodiment. The liner coupler comprises a latch assembly (401) having a latch element (403) and a handle element (404) rotatably coupled to the latch element. The latch assembly is rotatably coupled to an outer side surface (107) of a first major side (101) of the paint tray. The handle element is disposed below a periphery edge (109), and the latch element is configured to extend up and over the periphery edge. In some embodiments, the latch element may comprise a curvature configured to wrap around the periphery edge and press against an inner side surface (108). The liner coupler is preferably disposed at an upper portion (105) of the paint tray where a majority of weight is contained within the paint tray.

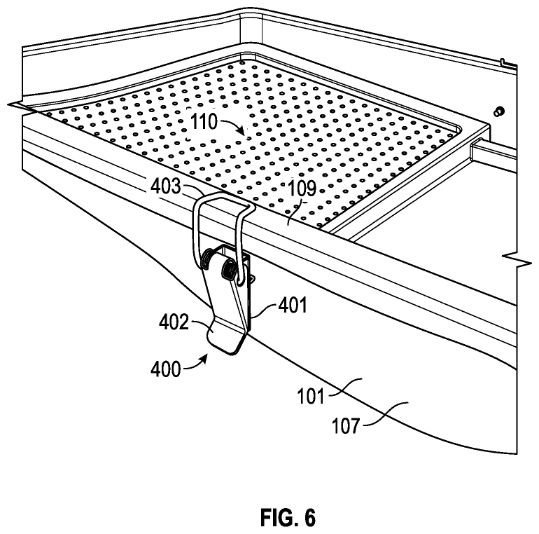

FIG. 6 shows a perspective view of the paint tray (100) with liner coupler (400) holding a paint tray liner (110) according to the third illustrated embodiment. The paint tray liner wraps around a periphery edge (109) of the paint tray once the paint tray liner is inserted. The liner coupler is coupled to the paint tray at an outer side surface (107) of a first major side (101). The liner coupler comprises a latch assembly (401) having a latch element (403) configured to contact one or more surfaces of the paint tray liner. In some embodiments, the latch element applies a downward force to the paint tray liner against the periphery edge, and additionally applies a side force to a section of paint tray liner aligned with the outer side surface. With two liner couplers disposed on opposite sides of the paint tray, the paint tray liner will undergo a downward force from each of the latch arms, and further undergo opposing side forces due to each of the latch arms disposed on opposite sides of the paint tray.

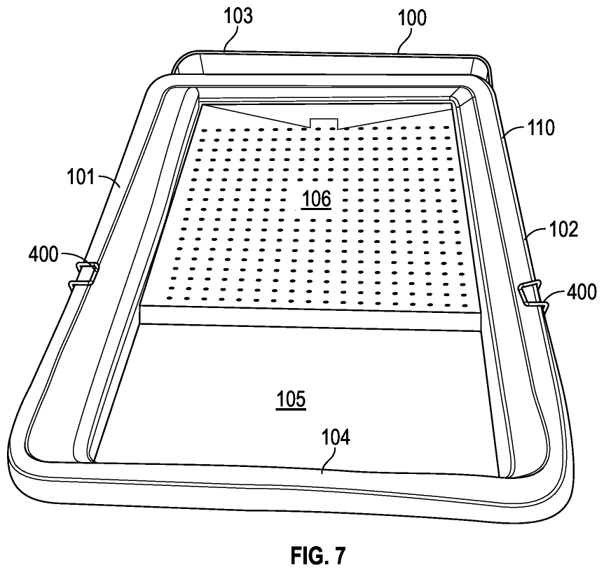

FIG. 7 shows a top view of the paint tray (100) with liner coupler (400) holding a paint tray liner (110) according to the third illustrated embodiment. As shown, the paint tray liner does not properly fit the paint tray. Two liner couplers are coupled to the paint tray and are engaged with the paint tray liner. Having at least two liner couplers disposed on opposite sides of the paint tray liner provides opposing side forces in addition to a downward force for a secured engagement. Having the liner couplers disposed on a first major side (101) and a second major side (102) of the paint tray prevents issues from a short paint tray, as shown, near the first minor side (103) and/or second minor side (104). Additionally, having the liner couplers disposed at an upper portion (105) of the paint tray allows the liner couplers to provide an engagement closest to the paint tray's center of gravity once paint is present.

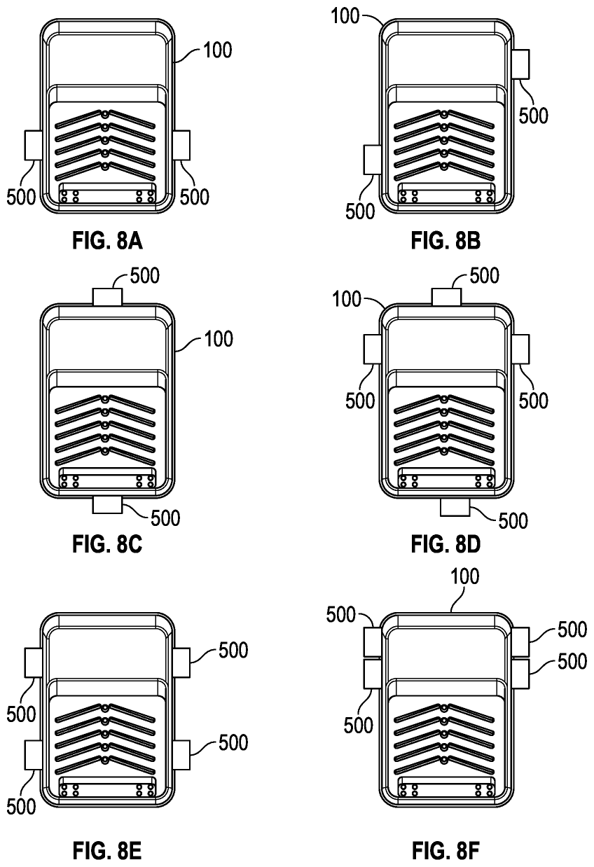

FIG. 8A-8F shows alternative configurations of liner couplers (500) coupled to the paint tray (100). Two or more liner couplers are coupled to various sides (major and minor) and portions (upper and lower) of the paint tray. A myriad of other line coupler configurations can be appreciated by one having skill in the art.

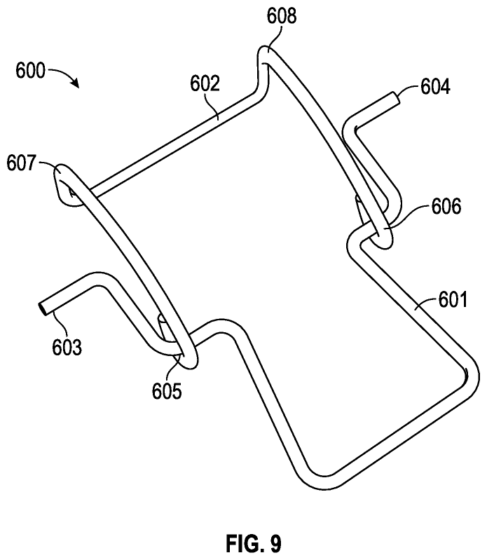

FIG. 9 shows a perspective view of a liner coupler (600) according to a fourth illustrated embodiment. The liner coupler comprises a latch element (602) rotatably coupled to a handle element (601). The latch element and handle element comprise distinct and separate parts. The latch element comprises a first looped formation (605) and a second looped formation (606), wherein the first and second looped formation are integrally formed with the latch element. The handle element comprises a first handle terminal end (603) and a second handle terminal end (604) wherein the first and second handle terminal ends are configured to attach to a side or upper edge of a paint tray via a coupler mounting element or other mechanism. The first handle terminal end extends through the first looped formation. The second handle terminal end extends through the second looped formation. The latch element comprises a first flexure (607) and a second flexure (608) wherein the first and second flexures are configured to grip an upper edge of a paint tray liner. In some embodiments, the liner coupler comprises a semi-rigid wire comprising metal, plastic, other similar materials, or a combination thereof.

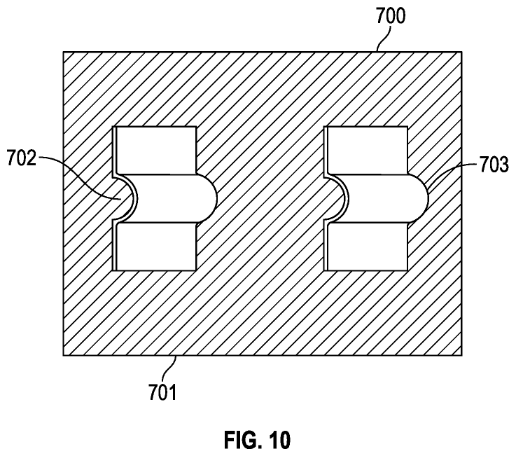

FIG. 10 shows a plan view of a coupler mounting element (700) used with a liner coupler, such as the liner coupler disclosed in FIG. 9 (600). The coupler mounting element comprises mounting plate (701). Disposed on an upper surface is a first aperture (702) and a second aperture (703). The mounting plate can be riveted, spot welded, or otherwise fixedly coupled to an outer side surface of a paint tray or other locations. The first and second apertures are configured to receive a first and second terminal ends of the liner coupler wherein the first and second terminal ends extend through the first and second apertures. The first and second terminal ends are configured to flex inwards to allow for insertion into the first and second apertures. In conjunction with the handle element (FIG. 9, 601), the first and second terminal ends can then retract back into an unflexed position thereby having the first and second terminal ends securely disposed within the first and second looped formations, respectively. The mounting plate allows for an easy and quick detachment and reattachment of liner couplers from the paint tray. This can be especially useful when replacement or cleaning of the liner couplers is desired. The liner couplers being detachable from the paint tray also allows for efficient stacking of paint trays during transportation and storage.

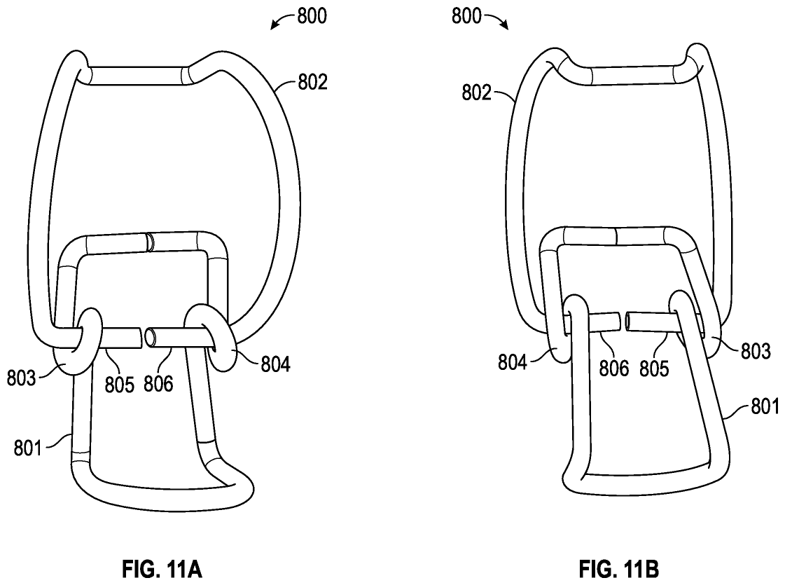

FIGS. 11A and 11B show a liner coupler (800) in accordance with a fifth illustrated embodiment, The liner coupler comprises a handle element (801) and a latch element (802) wherein the handle element is rotatably coupled to the latch element. The handle element comprises a first looped formation (803) and a second looped formation (804) each integrally formed by the handle element. The latch element comprises a first latch terminal end (805) and a second latch terminal end (806). The first latch terminal end extends through the first looped formation and the second latch terminal end extends through the second looped formation.

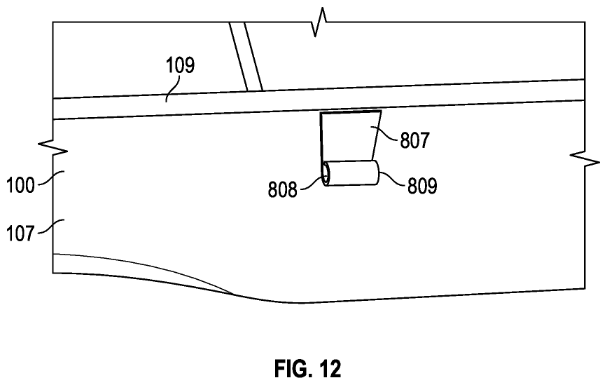

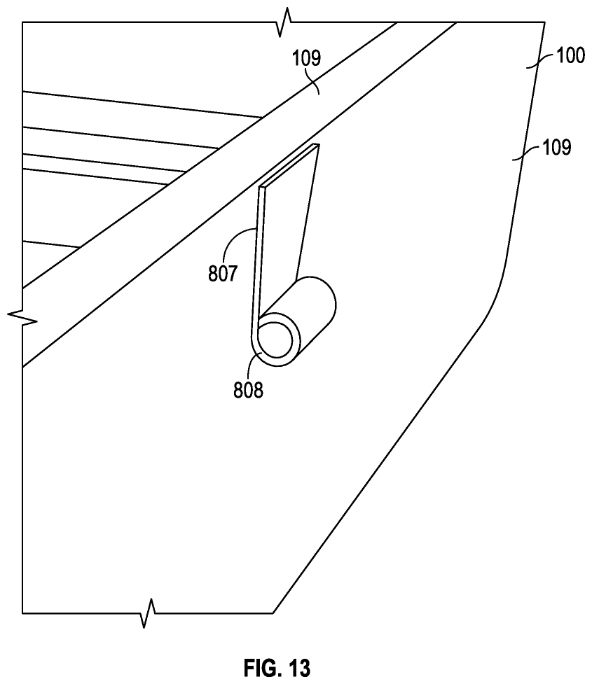

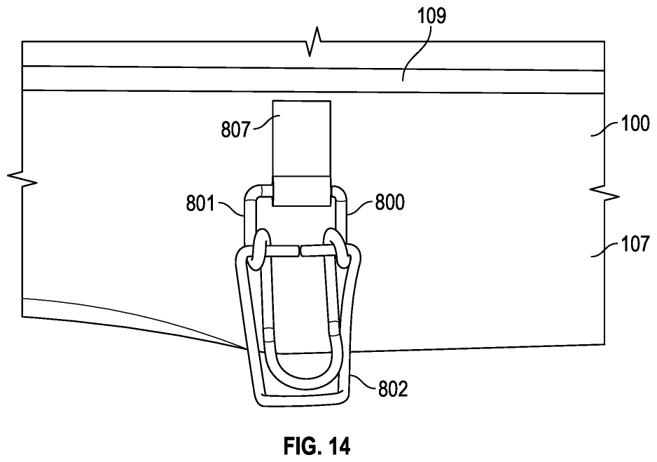

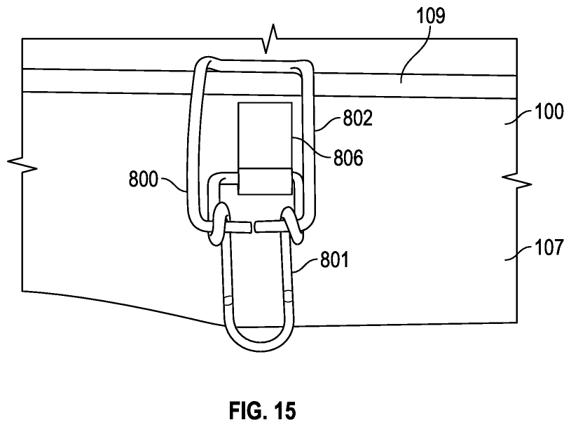

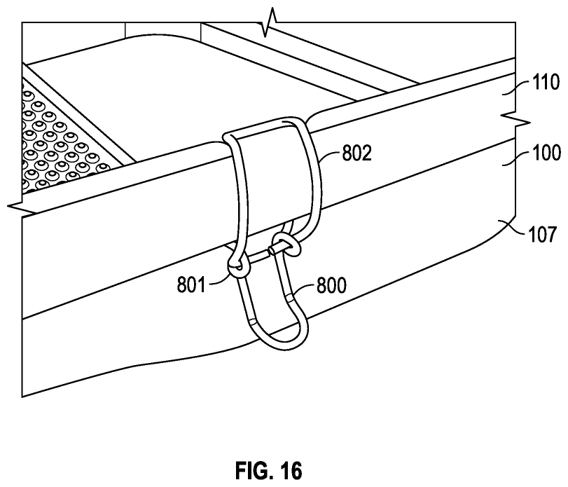

FIGS. 12-16 show a coupler mounting element (806) used in conjunction with the liner coupler (800) according to the fifth illustrated embodiment. The coupler mounting element is disposed on an outer side surface (107) of a paint tray (100). The coupler mounting element comprises a first aperture (808) and a second aperture (809) each configured to receive portions of the handle element (801). Once engaged, the handle element is configured to rotate in an upwards and downwards motion relative to the coupler mounting element. In some embodiments the coupler mounting element may comprise a distinct part and is fixedly coupled to the outer side surface by a coupling mechanism such as rivet, spot weld, or the like. In other embodiments, the coupler mounting element is fixedly coupled to the outer side surface by being integrally formed with the outer side surface.

The liner coupler (800) is configurable in either a locked position or an unlocked position. While in the unlocked position, the latch element (802) is disposed below a periphery edge (109) of the paint tray. While in the locked position, the latch element is disposed above the periphery edge and configured to apply a force to a paint tray liner (110) disposed therebetween.

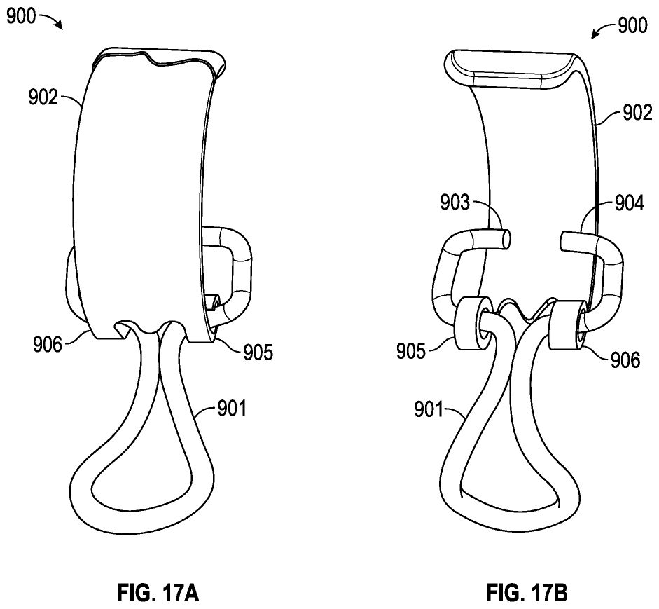

FIGS. 17A-17B show a liner coupler (900) in accordance with a sixth illustrated embodiment. The liner coupler comprises a handle element (901) and a latch element (902) wherein the handle element is rotatably coupled to the latch element. The latch element comprises a first looped formation (905) and a second looped formation (906) each coupled to the latch element. The handle element comprises a first handle terminal end (903) and a second handle terminal end (904). The first handle terminal end extends through the first looped formation and the second handle terminal end extends through the second looped formation.

While various details, features, and combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### FEATURE LIST

paint tray (100)

first major side (101)

second major side (102)

first minor side (103)

second minor side (104)

upper portion (105)

lower portion (106)

outer side surface (107)

inner side surface (108)

periphery edge (109)

paint tray liner (110)

liner coupler (200; 300; 400; 500; 600; 800; 900)

clasp lever (201)

tab (202)

rivet (203)

channel (204)

clamp (301)

first terminal end (302)

second terminal end (303)

first bend (304)

second bend (305)

third bend (306)

fourth bend (307)

top-adjoining portion (308)

inner side-adjoining portion (309)

latch assembly (401)

handle element (402; 601; 801; 901)

latch element (403; 602; 802; 902)

first handle terminal end (603; 903)

second handle terminal end (604; 904)

first looped formation (605; 803; 905)

second looped formation (606; 804; 906)

first flexure (607)

second flexure (608)

coupler mounting clement (700; 807)

mounting plate (701)

first aperture (702; 808)

second aperture (703; 809)

first latch terminal end (805)

second latch terminal end (806)

What is claimed is:

1. A paint tray coupler system, comprising:
a paint tray having a plurality of sides, the plurality of sides comprising a first major side, a second major side opposite the first major side, a first minor side and a second minor side opposite the first minor side,
wherein each of the plurality of sides comprises a periphery edge, an inner side surface and an outer side surface opposite the inner side surface,
the paint tray further comprising an upper portion and a lower portion wherein a well is disposed at the upper portion and a ridge slop is disposed at the lower portion; and
a coupler mounting element disposed on the outer side surface of one of the plurality of sides; and
a liner coupler configured to couple to the coupler mounting element, the liner coupler comprising a handle element configured to couple to the coupler mounting element, and a latch element rotatably coupled to the handle element.

2. The paint tray coupler system of claim 1, the coupler mounting element further comprising a first aperture and a second aperture wherein the liner coupler is configured to engage with the coupler mounting element at each of the first aperture and second aperture.

3. The paint tray coupler system of claim 1, the liner coupler further comprising a first looped formation and a second looped formation, wherein the first looped formation and the second looped formation are each disposed on the handle element, the latch element, or both.

4. The paint tray coupler system of claim 3, wherein the first looped formation and the second looped formation are each integrally formed onto the handle element, the latch element, or both.

5. The paint tray coupler system of claim 3, wherein the first looped formation and the second looped formation each comprise a plurality of bends of the handle element, the latch element, or both.

6. The paint tray coupler system of claim 3, the latch element further comprising a first latch terminal end and a second latch terminal end, wherein the first latch terminal end is configured to extend through the first looped formation and the second latch terminal end is configured to extend through the second looped formation.

7. The paint tray coupler system of claim 3, the handle element further comprising a first handle terminal end and a second handle terminal end, wherein the first handle terminal end is configured to extend through the first looped formation and the second handle terminal end is configured to extend through the second looped formation.

8. The paint tray coupler system of claim 1, wherein the handle element is configured to rotatably couple to the coupler mounting element.

9. The paint tray coupler system of claim 1, wherein the liner coupler is detachably coupled to the coupler mounting element.

10. The paint tray coupler system of claim 1, further comprising a plurality of coupler mounting elements wherein at least one of the plurality of coupler mounting elements is disposed on the outer side of each of the plurality of sides.

11. The paint tray coupler system of claim 1, wherein the coupler mounting element is integrally formed with the paint tray.

12. The paint tray coupler system of claim 1, the coupler mounting element further comprising a mounting plate wherein the mounting plate is coupled to the outer side surface.

13. The paint tray coupler system of claim 1, further comprising a paint tray liner disposed on top of the well and the ridge slope, the paint tray liner configured to cover the periphery edge wherein a portion of the paint tray liner is disposed between the periphery edge and the latch element.

14. The paint tray coupler system of claim 1, wherein the latch element is configured to be disposed above the periphery edge.

15. The paint tray coupler system of claim 1, wherein the handle element is configured to be disposed below the periphery edge.

16. The paint tray coupler system of claim 1, wherein the handle element and the latch element are configured to form a locked state.

17. The paint tray coupler system of claim 1, wherein the liner coupler is configured to apply a downward force, a sideways force, or both to the periphery edge.

18. The paint tray coupler system of claim 1, the latch element further comprising a curvature configured to engage with the periphery edge.

19. A paint tray coupler system, comprising:
a paint tray having a plurality of sides, the plurality of sides comprising a first major side, a second major side opposite the first major side, a first minor side and a second minor side opposite the first minor side,
wherein each of the plurality of sides comprises a periphery edge, an inner side surface and an outer side surface opposite the inner side surface,
the paint tray further comprising an upper portion and a lower portion wherein a well is disposed at the upper portion and a ridge slop is disposed at the lower portion; and
one or more liner couplers configured to couple to the outer side surface.

20. The paint tray coupler system of claim 1, wherein at least one of the one or more liner couplers is disposed at the upper portion.
